(19) United States
(12) Patent Application Publication
(10) Pub. No.: US 2025/0309416 A1
(43) Pub. Date: Oct. 2, 2025

(54) BATTERY, BATTERY MANUFACTURING DEVICE AND BATTERY MANUFACTURING METHOD

(71) Applicant: HONDA MOTOR CO., LTD., Tokyo (JP)

(72) Inventors: Keiichiro Oka, Wako-shi (JP); Hideaki Sasaki, Wako-shi (JP); Yoshihiko Nakajima, Wako-shi (JP)

(21) Appl. No.: 19/062,270

(22) Filed: Feb. 25, 2025

(30) Foreign Application Priority Data
Mar. 29, 2024 (JP) 2024-057622

(51) Int. Cl. H01M 50/136; H01M 10/04; H01M 50/105

(52) U.S. Cl. CPC H01M 50/136; H01M 10/0481; H01M 10/049; H01M 50/105; H01M 10/0404

(57) ABSTRACT

An all solid battery cell includes an electrode laminate, an exterior body, and a bent portion. The bent portion includes a first extension portion, a second extension portion folded from a tip portion of the first extension portion, and a third extension portion folded from a tip portion of the second extension portion. A length between the tip portion of the first extension portion and the tip portion of the second extension portion is greater than a thickness of the electrode laminate.

### CROSS-REFERENCE TO RELATED APPLICATION

Priority is claimed on Japanese Patent Application No. 2024-057622, filed Mar. 29, 2024, the content of which is incorporated herein by reference.

### BACKGROUND OF THE INVENTION

### Field of the Invention

The present invention relates to a battery, a battery manufacturing device and a battery manufacturing method.

### Description of Related Art

In recent years, there have been increasing attempts to provide access to a sustainable transportation system. To achieve this, for example, development of an all solid battery cell as a battery is underway. The all solid battery cell has an electrode laminate obtained by laminating a positive electrode layer, a negative electrode layer facing the positive electrode layer in a thickness direction, and a solid electrolyte layer disposed between the positive electrode layer and the negative electrode layer. The electrode laminate is covered with an exterior body such as a laminate film or the like. An all-solid battery module is formed by stacking a plurality of layers of all solid battery cells.

Here, the exterior body has a circumferential edge portion formed around the outer circumferential portion of the electrode laminate to seal the electrode laminate. The circumferential edge portion is formed by overlapping the exterior bodies and heat welding them together. For example, when two laminate films are overlapped in the thickness direction of the electrode laminate and the circumferential edges are heat welded, circumferential edge portions are formed on all four sides. For example, when one laminate film is bent to cover both sides of the electrode laminate in the thickness direction, the three sides excluding the bent portion are heat welded, circumferential edge portions are formed on the three sides. When the all-solid battery module is formed by stacking all solid battery cells without performing any processing such as the above mentioned circumferential edge portions, the volume energy density of the all-solid battery will be significantly reduced.

For this reason, a technology has been disclosed that improves the volume efficiency of the all-solid battery by miniaturizing the all solid battery cell or all-solid battery module by folding the circumferential edge portion (for example, see Japanese Patent No. 6935784).

The method of bending the circumferential edge portion of the exterior body includes a process of abutting a retaining plate against a starting point of bending of the circumferential edge portion, and a process of bending the circumferential edge portion by pressing the circumferential edge portion against the retaining plate using a pressing plate.

### SUMMARY OF THE INVENTION

However, in the technology in the related art, since the retaining plate is simply abutted against the starting point of bending of the circumferential edge portion, the load applied when bending the circumferential edge portion is transmitted to the electrode laminate, which could result in damage to the electrode laminate. In particular, if it is tried to fold the circumferential edge portion multiple times rather than simply folding it in half, there is a possibility that additional load will be applied to the electrode laminate. In this case, there was an issue with the quality of the all-solid battery deteriorating.

In addition, when the pressing load when folding the circumferential edge portion is reduced in order to improve the quality of the all solid battery cell, it is difficult to miniaturize the all solid battery cell or the all-solid battery module.

An aspect of the present invention is directed to providing a battery, a battery manufacturing device and a battery manufacturing method that are capable of improving quality and contributing to efficiency in terms of a volume energy density.

An aspect of the present invention proposes the following configurations.

(1) A battery (for example, an all solid battery cell (1) of an embodiment) according to the present invention includes an electrode laminate (for example, an electrode laminate (2) of the embodiment); an exterior body (for example, an exterior body (3) of the embodiment) configured to cover an entire of the electrode laminate by forming a circumferential edge portion (for example, a circumferential edge portion (52) of the embodiment) while overlapping an outer circumferential portion (for example, an outer circumferential portion (2a) of the embodiment) of the electrode laminate; and a bent portion (for example, a bent portion (55) of the embodiment) formed by folding a part of the circumferential edge portion, which is extending along one side of the outer circumferential portion of the electrode laminate, among the circumferential edge portion, the bent portion including: a first extension portion (for example, a first extension portion (57) of the embodiment) bent from a root portion (for example, a root portion (56) of the embodiment) of the circumferential edge portion, which is located near the outer circumferential portion, in a first direction among a thickness direction of the electrode laminate; a second extension portion (for example, a second extension portion (58) of the embodiment) folded from a tip portion (for example, a tip portion (57a) of the embodiment) of the first extension portion in a second direction, which is opposite to the first direction, among the thickness direction of the electrode laminate; and a third extension portion (for example, a third extension portion (59) of the embodiment) that is bent from a tip portion (for example, a tip portion (58a) of the embodiment) of the second extension portion in same direction as the first extension portion and that extends until the root portion in the first direction, and a length (for example, a length (L) of the embodiment) between the tip portion of the first extension portion and the tip portion of the second extension portion being greater than a thickness (for example, a thickness (H) of the embodiment) of the electrode laminate.

In this way, the battery can be made smaller, and the volume energy density can be improved in efficiency by forming the bent portion.

Here, among the bent portions, a load for bending the tip portion of the first extension portion and the tip portion of the second extension portion, which are folded back, tend to be a large. By positioning such a portion on an outer side of the electrode laminate in the thickness direction when viewed in the plane direction of the electrode laminate, it is possible to reliably prevent the load of the pressing portion from being transmitted to the electrode laminate when the circumferential edge portion is folded. For this reason, it is possible to improve quality of the battery.

(2) A battery manufacturing device (for example, a battery manufacturing device (100) of an embodiment) according to the present invention configured to fold a circumferential edge portion of an exterior body, the exterior body covering an electrode laminate from both sides in a thickness direction and forming the circumferential edge portion at an outer circumferential portion of the electrode laminate in an overlapping manner, thereby covering an entire of the electrode laminate, the battery manufacturing device including: a clamp portion (for example, a clamp portion (101) of the embodiment) configured to grip a root portion of the circumferential edge portion, which is located near the outer circumferential portion of the electrode laminate, while avoiding to grip both sides of the exterior body in the thickness direction of the electrode laminate; and a pressing portion (for example, a pressing portion (102) of the embodiment) configured to press a surplus portion of the circumferential edge portion, which is protruding from the clamp portion to a side opposite to the electrode laminate, toward the clamp portion and configured to bend the surplus portion of the circumferential edge portion.

With this configuration, the load of the pressing portion when folding the circumferential edge portion can be reliably received by the clamp portion. The clamp portion grips the circumferential edge portion while avoiding to grip both sides of of the exterior body in the thickness direction of the electrode laminate, thereby prevents the load received by the clamp portion from being transmitted to the electrode laminate. Moreover, the clamp portion grips the root portion of the circumferential edge portion, which is located near the outer circumferential portion of the electrode laminate, thereby enabling the surplus portion of the circumferential edge portion to be securely folded. For this reason, it is possible to improve the quality of the battery, and ultimately contribute to improving the efficiency of volume energy density.

(3) In the above-mentioned configuration, the surplus portion of the circumferential edge portion may include: a first extension portion bent from the root portion in a first direction among a thickness direction of the electrode laminate; and a second extension portion folded from a tip portion of the first extension portion in a second direction, which is opposite to the first direction, among the thickness direction of the electrode laminate.

By using the first extension portion and the second extension portion configured in this manner, for example, the exterior body and the heat transfer member can be brought into reliable contact with each other. Accordingly, it becomes possible to efficiently adjust the temperature of the electrode laminate via the heat transfer member. As a result, this will make it possible to improve battery performance and achieve longer battery life.

(4) In the above-mentioned configuration, the surplus portion of the circumferential edge portion may include a third extension portion that is bent from a tip portion of the second extension portion in same direction as the first extension portion and that extends until the root portion in the first direction.

By configuring in this manner, it is possible to easily form the bent portion of the circumferential edge portion flat. For this reason, this reduces the unevenness of the bent portion of the circumferential edge portion, making it possible, for example, to closely connect the exterior body and the heat transfer member.

(5) In the above-mentioned configuration, at least one of the tip portion of the first extension portion and the tip portion of the second extension portion may be located on an outer side of the electrode laminate in the thickness direction when viewed in a plane direction of the electrode laminate perpendicular to the thickness direction of the electrode laminate.

Here, the load caused by the pressing portion tends to be greater at the bent portion (turning point) of the circumferential edge portion. By positioning such a portion on an outer side of the electrode laminate in the thickness direction when viewed in the plane direction of the electrode laminate, it is possible to reliably prevent the load of the pressing portion from being transmitted to the electrode laminate when the circumferential edge portion is folded.

(6) In the above-mentioned configuration, the clamp portion may have a base portion (for example, a base portion (105) of the embodiment) provided at a position overlapping with the tip portion of the first extension portion and the tip portion of the second extension portion when viewed in the plane direction of the electrode laminate.

With this configuration, the load applied by the pressing portion to the bent portion (turning point) of the circumferential edge portion can be reliably transmitted to the base portion of the clamp portion. For this reason, this makes it possible to more reliably prevent damage to the electrode laminate. In addition, the pressing portion and the base portion ensure that the circumferential edge portion is bent, improving the bending properties of the bent portion.

(7) A battery manufacturing method according to the present invention is a battery manufacturing method of folding a circumferential edge portion of an exterior body, the exterior body, the exterior body covering an electrode laminate from both sides in a thickness direction and forming the circumferential edge portion at an outer circumferential portion of the electrode laminate in an overlapping manner, thereby covering an entire of the electrode laminate, the battery manufacturing method including: a gripping process of gripping a root portion of the circumferential edge portion, which is located near the outer circumferential portion of the electrode laminate, while avoiding to grip both sides of the exterior body in the thickness direction of the electrode laminate; and a pressing process of pressing a surplus portion of the circumferential edge portion, which is protruding to a side opposite to the electrode laminate than the gripped portion, toward the electrode laminate, and bending the surplus portion of the circumferential edge portion.

By using this method, it is possible to prevent the load, which is generated when folding back the circumferential edge portion, from being transmitted to the electrode laminate. Moreover, in the gripping process, since the root portion of the circumferential edge portion, which is located near the outer circumferential portion of the electrode laminate is gripped, the surplus of the outer circumferential portion can be reliably folded. For this reason, this will improve the quality of the battery, and ultimately contribute to improving the efficiency of volume energy density.

(8) In the pressing process of the above-mentioned method, the pressing process may have: a first extension forming process of bending the surplus portion of the circumferential edge portion from the root portion in a first direction among a thickness direction of the electrode laminate and forming a first extension portion; and a second extension forming process of folding a tip portion of the first extension portion in a second direction, which is opposite to the first direction, among a thickness direction of the electrode laminate, and forming a second extension portion.

By using this method, the first extension portion and the second extension portion can be formed. The first extension portion and the second extension portion can be used to ensure, for example, contact between the exterior body and the heat transfer member. Accordingly, it becomes possible to efficiently adjust the temperature of the electrode laminate via the heat transfer member. As a result, this will make it possible to improve battery performance and achieve longer battery life.

(9) In the pressing process of the above-mentioned method, the pressing process may have a third extension forming process of forming a third extension portion that is bent from a tip portion of the second extension portion in the same direction as the first extension portion and that extends until the root portion in the first direction.

By using this method, it is possible to easily form the bent portion of the circumferential edge portion flat. For this reason, this reduces the unevenness of the bent parts of the circumferential edge portion, making it possible, for example, to closely connect the exterior body and the heat transfer member.

(10) In the above-mentioned method, in at least one of the second extension forming process and the third extension forming process, at least one of the tip portion of the first extension portion and the tip portion of the second extension portion may be bent to be located on an outer side of the electrode laminate in the thickness direction when viewed in a plane direction of the electrode laminate perpendicular to the thickness direction of the electrode laminate.

Here, the load caused by the pressing portion tends to be greater at the bent portion (turning point) of the circumferential edge portion. By positioning such a portion on an outer side of the electrode laminate in the thickness direction when viewed in the plane direction of the electrode laminate, it is possible to reliably prevent the load of the pressing portion from being transmitted to the electrode laminate when the circumferential edge portion is folded.

According to the aspect of the present invention, it is possible to improve quality of the battery and contribute to efficiency of a volume energy density.

### BRIEF DESCRIPTION OF THE DRAWINGS

FIG. 1 is a plan view of an all solid battery according to an embodiment of the present invention.

FIG. 2 is a cross-sectional view along line II-II in FIG. 1.

FIG. 3 is a cross-sectional view along line III-III in FIG. 1.

FIG. 4 is a plan view before a bent portion of the all solid battery according to the embodiment of the present invention is formed.

FIG. 5 is a view for describing a manufacturing process of the bent portion according to the embodiment of the present invention.

FIG. 6 is a view for describing the manufacturing process of the bent portion according to the embodiment of the present invention.

FIG. 7 is a view for describing the manufacturing process of the bent portion according to the embodiment of the present invention.

### DETAILED DESCRIPTION OF THE INVENTION

Next, an embodiment of the present invention will be described with reference to the accompanying drawings.

### <All Solid Battery Cell>

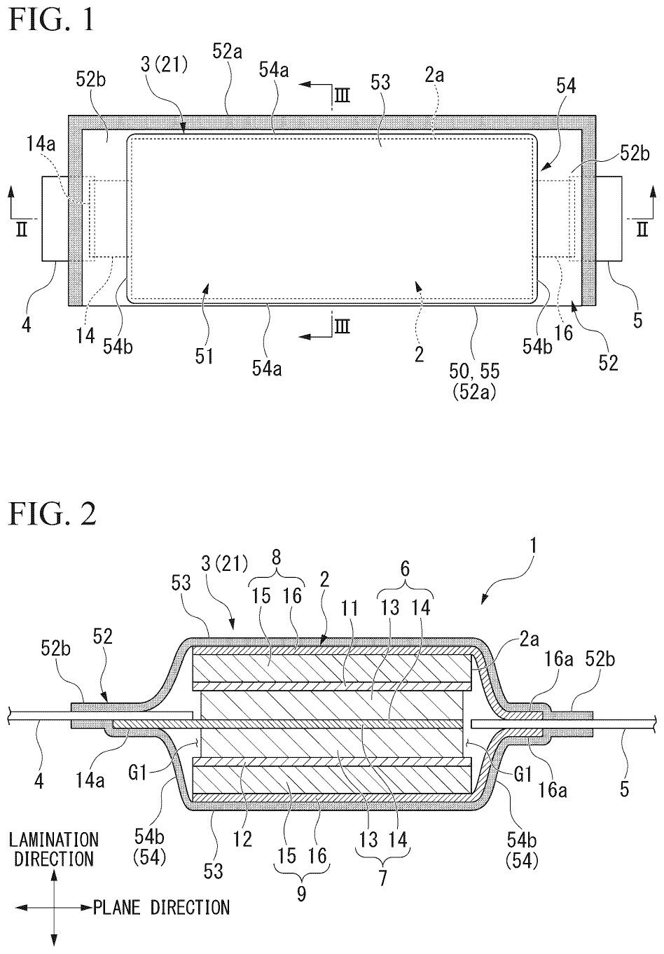

FIG. 1 is a plan view of an all solid battery cell 1. FIG. 2 is a cross-sectional view along line II-II in FIG. 1. In FIG. 1 and FIG. 2, a scale of each part has been appropriately changed to make the description easier to understand.

As shown in FIG. 1 and FIG. 2, the all solid battery cell 1 includes an electrode laminate 2, an exterior body 3 configured to cover the electrode laminate 2, and two lead tabs 4 and 5 (a positive electrode lead tab 4, a negative electrode lead tab 5) pulled out of the electrode laminate 2 via the exterior body 3.

### <Electrolyte Laminate>

The electrode laminate 2 is formed in a rectangular shape as a whole. The electrode laminate 2 mainly includes two positive electrode layers 6 and 7 (a first positive electrode layer 6, a second positive electrode layer 7) of each plate shape, two negative electrode layers 8 and 9 (a first negative electrode layer 8, a second negative electrode layer 9) disposed to face the positive electrode layers 6 and 7 in a thickness direction, respectively, and solid electrolyte layers 11 and 12 (a first solid electrolyte layer 11, a second solid electrolyte layer 12) disposed between each of the positive electrode layers 6 and 7 and each of the negative electrode layers 8 and 9.

The two positive electrode layers 6 and 7 each have a positive electrode active material layer 13. The two positive electrode layers 6 and 7 have a common positive electrode current collector 14. The positive electrode active material layers 13 are laminated on both sides with the positive electrode current collector 14 being sandwiched therebetween. Examples of the active materials that form the positive electrode active material layer 13 include lithium cobalt oxide, lithium nickel oxide, lithium manganese, lithium metal phosphate, lithium nickel cobalt manganese, lithium nickel cobalt aluminate, and the like.

The positive electrode current collector 14 is pulled out from the positive electrode active material layers 13 in a direction perpendicular to the laminating direction of the positive electrode active material layers 13 (hereinafter simply referred to as the laminating direction). The positive electrode current collector 14 is formed of metal foil, metal sheet, or metal plate, such as aluminum, copper, stainless steel, or the like.

In the following description, the direction perpendicular to the laminating direction is referred to as a plane direction. The laminating direction is a thickness direction of the electrode laminate 2.

The first negative electrode layer 8 in the two negative electrode layers 8 and 9 is disposed to face the first positive electrode layer 6 in the two positive electrode layers 6 and 7 in the laminating direction. The second negative electrode layer 9 in the two negative electrode layers 8 and 9 is disposed to face the second positive electrode layer 7 in the two positive electrode layers 6 and 7 in the laminating direction. More specifically, the first negative electrode layer 8 is disposed on a side of the first positive electrode layer 6 opposite to the second positive electrode layer 7. The second negative electrode layer 9 is disposed on a side of the second positive electrode layer 7 opposite to the first positive electrode layer 6.

The two negative electrode layers 8 and 9 each have a negative electrode active material layer 15. An area of the negative electrode active material layer 15 is greater than that of the positive electrode active material layer 13. For this reason, the negative electrode active material layer 15 overhangs in the plane direction further than the positive electrode active material layer 13. As a result, a gap G1 is formed between the negative electrode layers 8 and 9 in outer circumferential portions of the two negative electrode layers 8 and 9. The gap G1 can be said to be formed in the outer circumferential portions of the two positive electrode layers 6 and 7. In other words, the gap G1 is formed between the positive electrode layers 6 and 7 and the negative electrode layers 8 and 9.

Examples of the active materials that form the negative electrode active material layer 15 include, for example, lithium-based materials and silicon-based materials. Examples of the lithium-based materials include Li metal, Li alloys, and the like. Examples of the silicon-based materials include Si, SiO, and the like. Other examples of the active materials that form the negative electrode active material layer 15 include carbon materials such as graphite, soft carbon and hard carbon, tin-based materials (Sn, SnO, or the like), lithium titanate, and the like.

A negative electrode current collector 16 is laminated on a side of the negative electrode active material layer 15 opposite to the positive electrode layers 6 and 7. The negative electrode current collector 16 is formed of the same material as the positive electrode current collector 14. Each of the negative electrode current collectors 16 is pulled out of the negative electrode active material layer 15 in the plane direction. For example, the pulling-out direction is opposite to the pulling-out direction of the positive electrode current collector 14. A tip portion 16a in the pulling-out direction of each of the negative electrode current collectors 16 is bent toward the center in the laminating direction.

The first solid electrolyte layer 11 in the solid electrolyte layers 11 and 12 is disposed between the first positive electrode layer 6 and the first negative electrode layer 8. The second solid electrolyte layer 12 in the solid electrolyte layers 11 and 12 is disposed between the second positive electrode layer 7 and the second negative electrode layer 9. An area of each of the solid electrolyte layers 11 and 12 is the same as that of the negative electrode active material layer 15.

Each of the solid electrolyte layers 11 and 12 is formed of a solid electrolyte having, for example, ion conductivity. Examples of the material of the solid electrolyte layers 11 and 12 include a sulfide-based solid electrolyte material, an oxide-based solid electrolyte material, a nitride-based solid electrolyte material, a halide-based solid electrolyte material, and the like.

Further, the solid electrolyte layers 11 and 12, the positive electrode active material layer 13, and the negative electrode active material layer 15 may be formed by binding particles of the materials that form the layers with an organic polymer compound binder.

### <Exterior Body>

The exterior body 3 is formed, for example, by folding a laminate film 21 that forms the exterior body 3 in half. The laminate film 21 is formed by, for example, covering front and back surfaces of a metal layer with a resin layer (insulating layer). By configuring the exterior body 3 using the laminate film 21, the exterior body 3 has the flexibility to follow the expansion and contraction of the electrode laminate 2. The flexibility that can follow the expansion and contraction of the electrode laminate 2 can be obtained by a wrapping method, shape, structure, or the like, of the exterior body 3 with respect to the electrode laminate 2.

The exterior body 3 is integrally molded with a covering part 51 that covers the entire electrode laminate 2 and a circumferential edge portion 52 formed around the covering part 51. The covering part 51 is formed in a rectangular shape to correspond to the shape of the electrode laminate 2. That is, the covering part 51 is integrally molded with a pair of end surface covering parts 53 which cover the negative electrode current collector 16a from the outside in the laminating direction, and a side surface covering part 54 which is connected to the outer circumferential edges of the end surface covering parts 53 and covers an outer circumferential portion 2a of the electrode laminate 2. The outer circumferential portion 2a of the electrode laminate 2 is an outer side surface in the plane direction. Accordingly, the side surface covering part 54 has a long side surface covering part 54a facing in the short direction when viewed in the laminating direction, and a pair of short side surface covering parts 54b facing in the longitudinal direction.

The circumferential edge portion 52 is formed by overlapping the circumferential edges of the side surface covering parts 54 opposite to the end surface covering parts 53 in the laminating direction. Accordingly, the circumferential edge portion 52 has a pair of long circumferential edge portions 52a formed on the side of the long side surface covering part 54a and a pair of short circumferential edge portions 52b formed on the side of the short side surface covering parts 54b. Each of the circumferential edge portions 52a and 52b is formed centrally in the laminating direction of each of the side surface covering parts 54a and 54b.

One of the pair of long circumferential edge portions 52a has a surplus portion 50 that is larger than the surplus of the long circumferential edge portions 52a. A bent portion 55 is formed by folding the surplus portion 50 (the surplus of the long circumferential edge portions 52a).

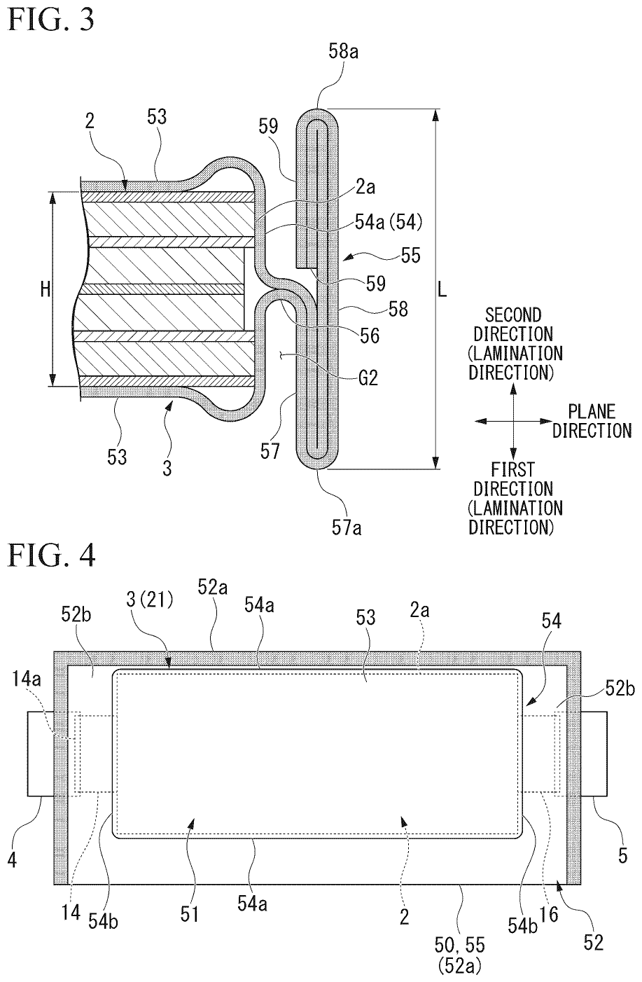

The bent portion 55 will be described with reference to FIG. 3.

FIG. 3 is a cross-sectional view along line III-III in FIG. 1. In the following description, one direction (downward in FIG. 3) in the laminating direction is referred to as a first direction. A direction (upward in FIG. 3) opposite to the first direction is referred to as a second direction.

As shown in FIG. 1 and FIG. 3, the bent portion 55 has a first extension portion 57 curved from a root portion 56 of the surplus portion 50 near the outer circumferential portion 2a of the electrode laminate 2, a second extension portion 58 curved from a tip portion 57a of the first extension portion 57 opposite to the root portion 56, and a third extension portion 59 curved from a tip portion 58a of the second extension portion 58 which is located at opposite side of the first extension portion 57.

The first extension portion 57 extends from the root portion 56 in the first direction. The first extension portion 57 is formed in a planar shape in the laminating direction. A small gap G2 is formed between the first extension portion 57 and the long side surface covering part 54a. The first extension portion 57 extends to the outside beyond the negative electrode current collector 16 in the laminating direction when viewed in the plane direction. In other words, the tip portion 57a of the first extension portion 57 is located outside of the electrode laminate 2 in the laminating direction when viewed in the plane direction.

The second extension portion 58 is formed by folding back the tip portion 57a of the first extension portion 57 to the side opposite to the electrode laminate 2, and then extending it in the second direction. The second extension portion 58 is formed in a planar shape in the laminating direction. The second extension portion 58 is overlapped on the side of the first extension portion 57 opposite to the electrode laminate 2. The second extension portion 58 extends to an outer side of the negative electrode current collector 16 in the laminating direction when viewed in the plane direction. In other words, the tip portion 58a of the second extension portion 58 is located on an outer side of the electrode laminate 2 opposite to the tip portion 57a of the first extension portion 57 when viewed in the plane direction.

That is, a length L between the tip portion 57a of the first extension portion 57 and the tip portion 58a of the second extension portion 58 is greater than a thickness H of the electrode laminate 2.

The third extension portion 59 is formed by folding back the tip portion 58a of the second extension portion 58 towards the electrode laminate 2 and then extending it in the first direction. The third extension portion 59 is formed in a planar shape in the laminating direction. The third extension portion 59 is overlapped on the surface of the second extension portion 58 on the side of the electrode laminate 2. That is, the third extension portion 59 is disposed on the same plane as the first extension portion 57 in the laminating direction. The third extension portion 59 extends just before the root portion 56. In other words, a tip portion 59a of the third extension portion 59 is disposed near the root portion 56.

### <Lead Tab>

Returning to FIG. 1 and FIG. 2, one end portion of the positive electrode lead tab 4 in the two lead tabs 4 and 5 is connected to a tip portion 14a of the positive electrode current collector 14. The positive electrode lead tab 4 extends in the plane direction. The other end portion of the positive electrode lead tab 4 is pulled out to the outside of the exterior body 3 via the short circumferential edge portions 52b of the exterior body 3.

One end portion of the negative electrode lead tab 5 in the two lead tabs 4 and 5 is connected to the tip portion 16a of the negative electrode current collector 16 on each of both surfaces. The negative electrode lead tab 5 extends in the plane direction. An extension direction of the negative electrode lead tab 5 is, for example, a side opposite to the positive electrode lead tab 4. The other end portion of the negative electrode lead tab 5 is pulled out to the outside of the exterior body 3 via the short circumferential edge portions 52b of the exterior body 3.

The two lead tabs 4 and 5 are formed of a metal sheet or metal plate having, for example, conductivity.

The all solid battery cell 1 charges or discharges the electrode laminate 2 by connecting it to a charger or an electrical load via the two lead tabs 4 and 5.

### <Battery Manufacturing Device and Battery Manufacturing Method>

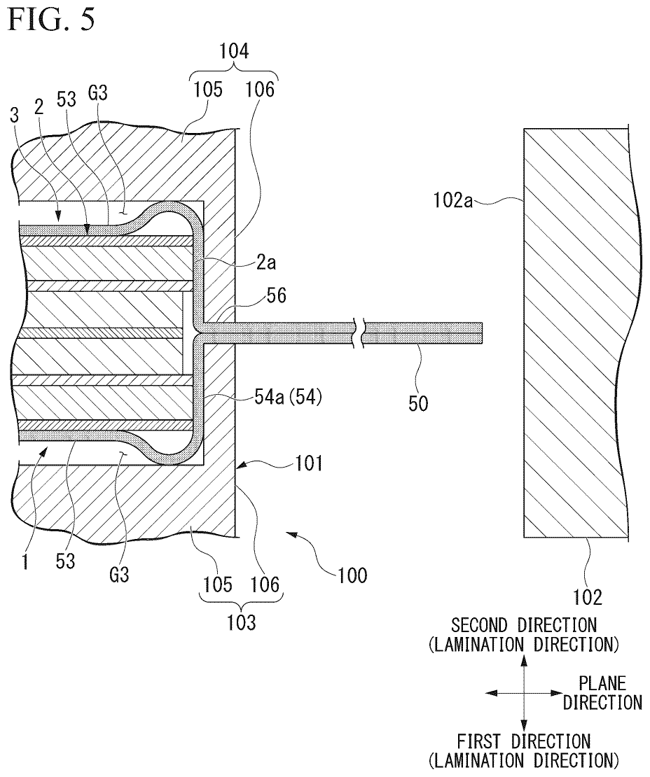

Next, a battery manufacturing device 100 configured to form the bent portion 55 of the all solid battery cell 1 and a battery manufacturing method of forming the bent portion 55 using the battery manufacturing device 100 will be described with reference to FIG. 4 to FIG. 7. FIG. 4 is a plan view before forming the bent portion 55 of the all solid battery cell 1. FIG. 4 corresponds to FIG. 1 described above. FIG. 5 to FIG. 7 are views for describing a manufacturing process of the bent portion 55. FIG. 5 to FIG. 7 correspond to FIG. 3 described above.

As shown in FIG. 4 and FIG. 5, the all solid battery cell 1 before forming the bent portion 55 has the surplus portion 50 overhanging in the plane direction.

The battery manufacturing device 100 includes a clamp portion 101 configured to grip the surplus portion 50 from both sides in the laminating direction, and a pressing portion 102 configured to press the surplus portion 50 protruding from the clamp portion 101 toward the clamp portion 101.

The clamp portion 101 includes a pair of grip portions 103 and 104. The pair of grip portions 103 and 104 (a first grip portion 103, a second grip portion 104) are disposed symmetrically about a center of the electrode laminate 2. For this reason, in the following description, only the first grip portion 103 in the pair of grip portions 103 and 104 will be described. The second grip portion 104 in the pair of grip portions 103 and 104 is designated by the same reference sign as the first grip portion 103 and description thereof will be omitted.

The first grip portion 103 includes a base portion 105 disposed to facing the end surface covering parts 53 in the laminating direction at a predetermined interval G3, and claw portions 106 provided on an end portion of the base portion 105 in the plane direction. The claw portions 106 protrude from the base portion 105 in directions facing each other. The grip portions 103 and 104 are arranged so that they can move toward and away from each other.

The pressing portion 102 is positioned on the opposite side of the all solid battery cell 1 from the claw portions 106. The pressing portion 102 has a planar surface 102a facing the outer circumferential portion 2a of the electrode laminate 2 in the plane direction. The planar surface 102a is aligned in the laminating direction. The pressing portion 102 is arranged to be able to approach and move away from the claw portions 106.

With this configuration, as shown in FIG. 5, first, the grip portions 103 and 104 are brought closer together, and the root portion 56 of the surplus portion 50 is gripped by the claw portions 106 (gripping process).

Here, since the base portion 105 is disposed to face the end surface covering parts 53 in the laminating direction with the predetermined interval G3 therebetween, contact between the base portion 105 and the end surface covering parts 53 is avoided. In other words, the clamp portion 101 grips the root portion 56 while avoiding gripping the end surface covering parts 53.

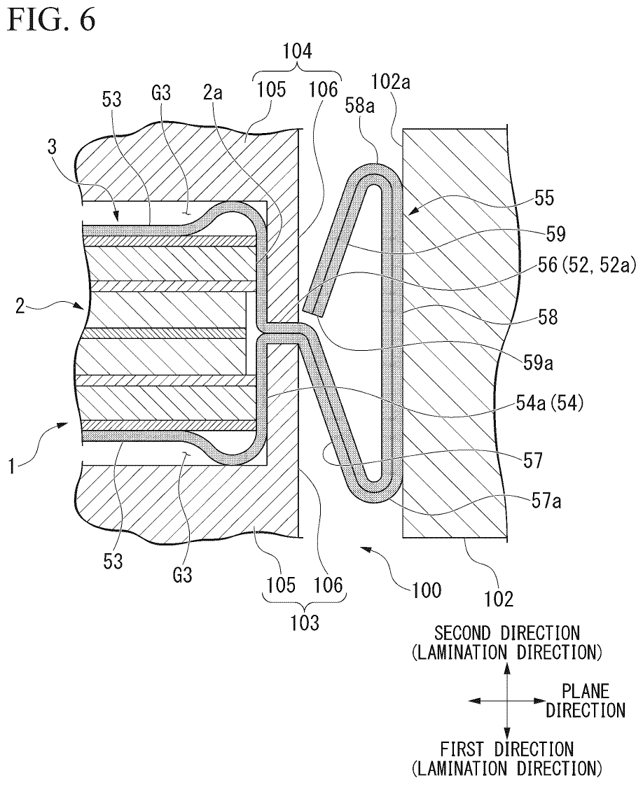

Next, as shown in FIG. 6, using a jig (not shown), the surplus of the surplus portion 50 protruding from the clamp portion 101 to the opposite side of the electrode laminate 2 is pressed by the pressing portion 102 (pressing process). The pressing portion 102 presses the surplus portion 50 toward the clamp portion 101. Accordingly, the bent portion 55 is bent.

In the pressing process, first, the jig (not shown) is used to bend the surplus portion 50 in the first direction using the claw portions 106 as the starting point. Accordingly, the first extension portion 57 is formed roughly (first extension forming process).

The tip portion 57a of the first extension portion 57 is folded back toward the opposite side of the electrode laminate 2 and in the second direction. Accordingly, the second extension portion 58 is formed (second extension forming process).

The tip portion 58a of the second extension portion 58 is folded back toward the electrode laminate 2 in the first direction. Accordingly, the third extension portion 59 is formed (third extension forming process).

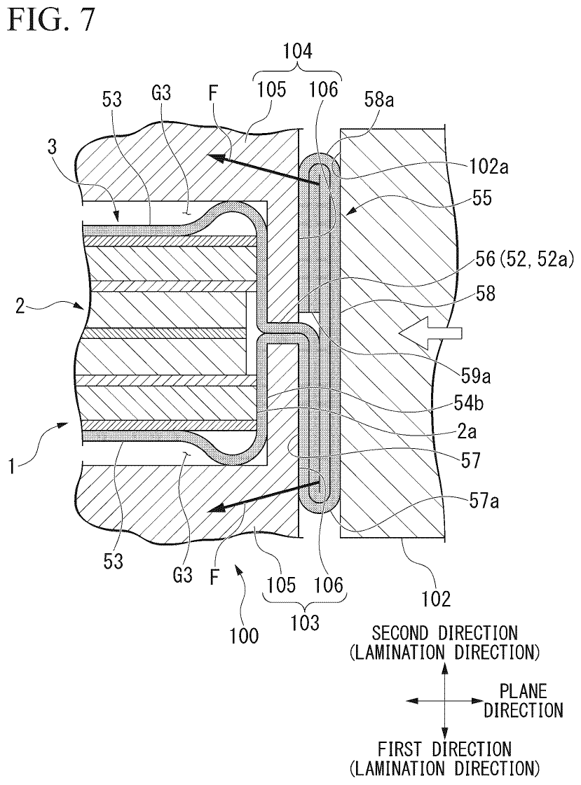

After that, as shown in FIG. 7, each of the extension portions 57, 58 and 59 is pressed by the pressing portion 102. Here, the pressing portion 102 is pressed until the pressing portion 102 and the claw portions 106 sandwich each of the extension portions 57, 58 and 59. Accordingly, the surplus portion 50 is then fully folded to complete the construction of the bent portion 55. Here, the gap G2 is formed between the first extension portion 57 and the long side surface covering part 54a by the thickness of the claw portions 106.

Incidentally, the tip portion 57a of the first extension portion 57, which is the turning point from the first extension portion 57 to the second extension portion 58, and the tip portion 58a of the second extension portion 58, which is the turning point from the second extension portion 58 to the third extension portion 59, are located on an outer side of the electrode laminate 2 in the laminating direction when viewed in the plane direction. The positions of the tip portions 57a and 58a overlap with the base portion 105 when viewed in the plane direction.

Here, the load on the bent portion 55 due to the pressing portion 102 tends to be large at the turning point of the bent portion 55. By positioning such a portion outside of the electrode laminate 2 in the laminating direction when viewed in the plane direction, a load F of the pressing portion 102 applied to the turning point when forming the bent portion 55 is prevented from being transmitted to the electrode laminate 2. Moreover, the avoided load F is reliably received by the base portion 105.

In this way, the all solid battery cell 1 described above has the surplus portion 50 folded to form the bent portion 55. For this reason, the all solid battery cell 1 can be made smaller, and volume energy density can be improved in efficiency.

The bent portion 55 has the first extension portion 57, the second extension portion 58, and the third extension portion 59. The length L between the tip portion 57a of the first extension portion 57 and the tip portion 58a of the second extension portion 58 is greater than the thickness H of the electrode laminate 2. For this reason, it is possible to prevent the load F of the pressing portion 102 applied to the turning point when the bent portion 55 is formed from being transmitted to the electrode laminate 2. Accordingly, damage to the electrode laminate 2 can be prevented, and quality of the all solid battery cell 1 can be improved.

The battery manufacturing device 100 described above includes the clamp portion 101, and the pressing portion 102. For this reason, the load of the pressing portion 102 when forming the bent portion 55, i.e., the load of the pressing portion 102 when folding the surplus portion 50, can be reliably received by the clamp portion 101. The clamp portion 101 grips the surplus portion 50 (the long circumferential edge portions 52a) while avoiding gripping the end surface covering parts 53, that is, while avoiding gripping both sides of the electrode laminate 2 in the laminating direction in the exterior body 3. For this reason, it is possible to prevent the load received by the clamp portion 101 from being transmitted to the electrode laminate 2. Moreover, the clamp portion 101 grips the root portion 56 of the surplus portion 50, thereby allowing the surplus portion 50 to be securely folded. For this reason, it is possible to improve quality of the all solid battery cell 1 and contribute to efficiency of volume energy density.

Since the bent portion 55 has the first extension portion 57 and the second extension portion 58, the first extension portion 57 and the second extension portion 58 can be used to ensure contact between, for example, the exterior body 3 and a heat transfer member (not shown). The heat transfer member is a member that easily transfers heat. For example, aluminum alloy or copper alloy is exemplified. Accordingly, it becomes possible to efficiently adjust the temperature of the electrode laminate 2 via the heat transfer member. More specifically, the electrode laminate 2 can be easily heated and cooled. As a result, this will make it possible to improve the performance of the all solid battery cell 1 and achieve an extended lifespan.

The bent portion 55 further has the third extension portion 59, which makes it easier to form the bent portion 55 flat. As a result, this reduces the unevenness of the bent portion 55, for example, making it possible to closely connect the exterior body 3 and the heat transfer member (not shown).

The tip portion 57a of the first extension portion 57 and the tip portion 58a of the second extension portion 58 are located on an outer side of the electrode laminate 2 in the laminating direction. For this reason, this makes it possible to prevent the load F of the pressing portion 102 applied to the turning point when the bent portion 55 is formed from being transmitted to the electrode laminate 2. Accordingly, damage to the electrode laminate 2 can be prevented.

The tip portion 57a of the first extension portion 57 and the tip portion 58a of the second extension portion 58 are positioned so as to overlap with the base portion 105 when viewed in the plane direction. For this reason, the load F of the pressing portion 102 applied to the turning point when the bent portion 55 is formed can be reliably received by the base portion 105. It is possible to effectively prevent the load F from being transmitted to the electrode laminate 2. Accordingly, this makes it possible to more reliably prevent damage to the electrode laminate 2. In addition, the base portion 105 and the pressing portion 102 ensure that the bent portion 55 is formed reliably, thereby improving the bending properties of the bent portion 55.

The method of manufacturing the bent portion 55 includes a gripping process and a pressing process. By using this method, the load applied when folding the surplus portion 50 can be prevented from being transmitted to the electrode laminate 2. Moreover, in the gripping process, since the root portion 56 of the surplus portion 50 is gripped, the surplus portion 50 can be folded securely. For this reason, it is possible to improve quality of the all solid battery cell 1 and contribute to efficiency of the volume energy density.

The present invention is not limited to the above-mentioned embodiment, but includes various modifications of the above-mentioned embodiment without departing from the scope of the present invention.

For example, in the above-mentioned embodiment, the case where the area of the negative electrode active material layer 15 is larger than the area of the positive electrode active material layer 13 has been described. The area of each of the solid electrolyte layers 11 and 12 is described as being equal to the area of the negative electrode active material layer 15. However, there is no limitation thereto, and the area of the positive electrode active material layer 13, the area of the negative electrode active material layer 15, and the areas of the solid electrolyte layers 11 and 12 can be determined arbitrarily. For example, the area of each of the solid electrolyte layers 11 and 12 may be smaller than the area of the positive electrode active material layer 13 and the area of the negative electrode active material layer 15. The area of the positive electrode active material layer 13 may be larger than the area of the negative electrode active material layer 15.

In the above-mentioned embodiment, the case in which the two positive electrode layers 6 and 7 and the two negative electrode layers 8 and 9 are provided has been described. However, there is no limitation thereto, and the positive electrode layer and the negative electrode layer may be one layer or three or more layers. The solid electrolyte layers 11 and 12 may be disposed between the positive electrode layer and the negative electrode layer.

In the above-mentioned embodiment, the case in which the first negative electrode layer 8 is disposed on the opposite side of the first positive electrode layer 6 from the second positive electrode layer 7 has been described. The case in which the second negative electrode layer 9 is disposed on the opposite side of the first positive electrode layer 6 from the second positive electrode layer 7 has been described. However, there is no limitation thereto, and the arrangement of the positive electrode layers 6 and 7 and the negative electrode layers 8 and 9 may be reversed.

In the above-mentioned embodiment, the case in which the third extension portion 59 is bent and formed at the tip portion 58a of the second extension portion 58 at the bent portion 55 has been described. However, there is no limitation thereto, and the bent portion 55 may have at least the first extension portion 57 and the second extension portion 58.

In the above-mentioned embodiment, the case in which the tip portion 57a of the first extension portion 57 and the tip portion 58a of the second extension portion 58 are each positioned on an outer side of the electrode laminate 2 in the laminating direction when viewed in the plane direction has been described. However, there is no limitation thereto, and it is sufficient that at least one of the tip portion 57a of the first extension portion 57 and the tip portion 58a of the second extension portion 58 is located on an outer side of the electrode laminate 2 in the laminating direction when viewed in the plane direction. Even when configured in this manner, damage to the electrode laminate 2 during the formation of the bent portion 55 can be suppressed compared to when each of the tip portions 57a and 58a is not positioned on an outer side of the electrode laminate 2 in the laminating direction when viewed in the plane direction.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A battery comprising:
an electrode laminate;
an exterior body configured to cover an entire of the electrode laminate by forming a circumferential edge portion while overlapping an outer circumferential portion of the electrode laminate; and
a bent portion formed by folding a part of the circumferential edge portion, which is extending along one side of the outer circumferential portion of the electrode laminate, among the circumferential edge portion,
wherein the bent portion comprises:
a first extension portion bent from a root portion of the circumferential edge portion, which is located near the outer circumferential portion, in a first direction among a thickness direction of the electrode laminate;
a second extension portion folded from a tip portion of the first extension portion in a second direction, which is opposite to the first direction, among the thickness direction of the electrode laminate; and
a third extension portion that is bent from a tip portion of the second extension portion in same direction as the first extension portion and that extends until the root portion in the first direction, and
a length between the tip portion of the first extension portion and the tip portion of the second extension portion is greater than a thickness of the electrode laminate.

2. A battery manufacturing device configured to fold a circumferential edge portion of an exterior body, the exterior body covering an electrode laminate from both sides in a thickness direction and forming the circumferential edge portion at an outer circumferential portion of the electrode laminate in an overlapping manner, thereby covering an entire of the electrode laminate, the battery manufacturing device comprising:
a clamp portion configured to grip a root portion of the circumferential edge portion, which is located near the outer circumferential portion of the electrode laminate, while avoiding to grip both sides of the exterior body in the thickness direction of the electrode laminate; and
a pressing portion configured to press a surplus portion of the circumferential edge portion, which is protruding from the clamp portion to a side opposite to the electrode laminate, toward the clamp portion and configured to bend the surplus portion of the circumferential edge portion.

3. The battery manufacturing device according to claim 2, wherein the surplus portion of the circumferential edge portion comprises:
a first extension portion bent from the root portion in a first direction among a thickness direction of the electrode laminate; and
a second extension portion folded from a tip portion of the first extension portion in a second direction, which is opposite to the first direction, among the thickness direction of the electrode laminate.

4. The battery manufacturing device according to claim 3, wherein the surplus portion of the circumferential edge portion includes a third extension portion that is bent from a tip portion of the second extension portion in same direction as the first extension portion and that extends until the root portion in the first direction.

5. The battery manufacturing device according to claim 4, wherein at least one of the tip portion of the first extension portion and the tip portion of the second extension portion is located on an outer side of the electrode laminate in the thickness direction when viewed in a plane direction of the electrode laminate perpendicular to the thickness direction of the electrode laminate.

6. The battery manufacturing device according to claim 5, wherein the clamp portion has a base portion provided at a position overlapping with the tip portion of the first extension portion and the tip portion of the second extension portion when viewed in the plane direction of the electrode laminate.

7. A battery manufacturing method of folding a circumferential edge portion of an exterior body, the exterior body, the exterior body covering an electrode laminate from both sides in a thickness direction and forming the circumferential edge portion at an outer circumferential portion of the electrode laminate in an overlapping manner, thereby covering an entire of the electrode laminate, the battery manufacturing method comprising:
a gripping process of gripping a root portion of the circumferential edge portion, which is located near the outer circumferential portion of the electrode laminate, while avoiding to grip both sides of the exterior body in the thickness direction of the electrode laminate; and
a pressing process of pressing a surplus portion of the circumferential edge portion, which is protruding to a side opposite to the electrode laminate than the gripped portion, toward the electrode laminate, and bending the surplus portion of the circumferential edge portion.

8. The battery manufacturing method according to claim 7, wherein the pressing process has:
a first extension forming process of bending the surplus portion of the circumferential edge portion from the root portion in a first direction among a thickness direction of the electrode laminate, and forming a first extension portion; and
a second extension forming process of folding a tip portion of the first extension portion in a second direction, which is opposite to the first direction, among a thickness direction of the electrode laminate, and forming a second extension portion.

9. The battery manufacturing method according to claim 8, wherein the pressing process has a third extension forming process of forming a third extension portion that is bent from a tip portion of the second extension portion in the same direction as the first extension portion and that extends until the root portion in the first direction.

10. The battery manufacturing method according to claim 9, wherein, in at least one of the second extension forming process and the third extension forming process, at least one of the tip portion of the first extension portion and the tip portion of the second extension portion is bent to be located on an outer side of the electrode laminate in the thickness direction when viewed in a plane direction of the electrode laminate perpendicular to the thickness direction of the electrode laminate.
